(19) United States
(12) Patent Application Publication
(10) Pub. No.: US 2026/0253005 A1
(43) Pub. Date: Aug. 27, 2026

(54) INTEGRATED PROJECT CONTROL SYSTEMS AND METHODS USING TEMPORAL DEPENDENCY MODELING

(71) Applicant: Foresight Works Ltd, London (GB)

(72) Inventors: Atif ANSAR, London (GB); Igor SHYFRIN, New York, NY (US)

(21) Appl. No.: 19/538,224

(22) Filed: Feb. 12, 2026

Related U.S. Application Data
(63) Continuation-in-part of application No. 18/120,324, filed on Mar. 10, 2023, now Pat. No. 12,572,895.

(51) Int. Cl. G06Q 10/0633; G06Q 10/0635; G06Q 10/067; G06Q 10/10

(52) U.S. Cl. CPC G06Q 10/06334; G06Q 10/0635; G06Q 10/0674; G06Q 10/103

(57) ABSTRACT

A computer-implemented system and method for analyzing, forecasting, and controlling execution of complex projects is disclosed. The system ingests heterogeneous project data, including schedule data, procurement data, execution progress data, and historical project datasets, and normalizes the data into structured data objects stored in non-transitory memory. One or more processors construct and maintain an authoritative temporal data model represented as a directed dependency graph encoding activities, milestones, and time relationships. The system computes planned, actual, and forecasted progress metrics and performs schedule quality analysis, change detection, risk assessment, and completion forecasting using algorithmic processing, probabilistic modeling, and machine learning models trained on historical execution data. Automated reporting and narrative generation are performed based on analytic outputs, and a structured collaboration and execution coordination framework enables controlled evaluation of execution changes while preserving integrity of the temporal data model.

A computer-implemented system and method for analyzing, forecasting, and controlling execution of complex projects is disclosed. The system ingests heterogeneous project data, including schedule data, procurement data, execution progress data, and historical project datasets, and normalizes the data into structured data objects stored in non-transitory memory. One or more processors construct and maintain an authoritative temporal data model represented as a directed dependency graph encoding activities, milestones, and time relationships. The system computes planned, actual, and forecasted progress metrics and performs schedule quality analysis, change detection, risk assessment, and completion forecasting using algorithmic processing, probabilistic modeling, and machine learning models trained on historical execution data. Automated reporting and narrative generation are performed based on analytic outputs, and a structured collaboration and execution coordination framework enables controlled evaluation of execution changes while preserving integrity of the temporal data model.

### RELATED APPLICATION

The present application is a continuation-in-part of U.S. patent application Ser. No. 18/120,324 filed on Mar. 10, 2023.

### FIELD OF THE INVENTION

The present invention relates to the field of information processing and project management. More particularly, embodiments in accordance with the present invention are related to systems and methods for visualizing and managing project flows.

### BACKGROUND

A megaproject is a large-scale, complex and often expensive project that involves multiple stakeholders, has a significant impact on its surrounding environment, and is characterized by its size, scope, and level of complexity. Examples of megaprojects include large infrastructure projects like high-speed rail systems, airports, seaports, and highways, as well as large construction projects like shopping centers, stadiums, and theme parks. Megaprojects often involve multiple partners, including government agencies, private companies, and other organizations, and require coordination and cooperation among these partners to ensure their successful completion. Because of their size and complexity, megaprojects can also pose significant risks, including cost overruns, delays, and negative impacts on the environment and local communities.

Megaprojects are extremely difficult to manage due to a number of factors. Megaprojects are large, complex endeavors that involve multiple stakeholders, extensive planning, and the coordination of many different activities. This level of complexity makes it challenging to manage all the moving parts and ensure that everything is running smoothly. Megaprojects are usually much larger in scale than traditional projects, which makes it difficult to manage the many resources involved and ensure that everything is progressing as planned. Many megaprojects involve a high degree of uncertainty, such as unexpected changes in the economy, political instability, and fluctuations in resource costs. These uncertainties can make it difficult to manage the project effectively and maintain a clear vision of the end goal. Furthermore, megaprojects often involve many stakeholders with different interests, priorities, and perspectives, which can make it difficult to achieve consensus and resolve conflicts. By their very nature, megaprojects are often very expensive, and cost overruns and delays are common due to the complexity and scale of the projects. These overruns and delays can be difficult to manage and can have a significant impact on the project budget and time. Lastly, megaprojects involve a significant amount of risk, including technical, financial, and legal risks. Managing these risks effectively is essential to the success of the project, but it can be challenging due to the complexity of the project and the difficulty of predicting and mitigating risks.

### SUMMARY

The present invention relates to systems and methods for analyzing, forecasting, and controlling time-dependent execution of complex projects using artificial intelligence and computer programmed schedule processing. The system ingests heterogeneous project data, including schedule data, procurement data, execution progress data, and historical project datasets, and normalizes such data into structured data objects stored in non-transitory memory.

One or more processors construct and maintain an authoritative temporal data model represented as a directed dependency graph encoding activities, milestones, and time relationships. The system computes planned, actual, and forecasted progress metrics by evaluating activity state transitions, duration consumption, and dependency traversal, and applies weighting functions based on downstream impact factors. Schedule quality, change detection, risk assessment, and completion forecasting are performed using processor-executed validation routines, probabilistic modeling, and machine learning models trained on historical execution data.

The system further generates automated reports and machine-generated narrative explanations based on analytic outputs, and provides a structured collaboration and execution coordination framework that preserves integrity of the authoritative temporal model while enabling controlled evaluation of proposed execution changes. By integrating artificial intelligence, graph-based temporal modeling, and automated analytics within a unified computing system, the invention provides an improvement to project scheduling and control technology by enabling continuous, predictive computation of execution state, risk, and delivery outcomes.

### BRIEF DESCRIPTION OF DRAWINGS

The accompanying drawings, which are incorporated in and form a part of this specification and in which like numerals depict like elements, illustrate embodiments of the present disclosure and, together with the detailed description, serve to explain the principles of the disclosure.

FIG. 1 illustrates a block diagram of an exemplary system for visualizing and managing project flows, in accordance with embodiments of the present invention.

FIG. 2 illustrates a flow chart of an exemplary process for building project activity sets and comparative project activity sets, in accordance with embodiments of the present invention.

FIG. 3 illustrates a flow chart of an exemplary process 300 for scheduling comparative risk, in accordance with embodiments of the present invention.

FIG. 4 illustrates a flow chart of an exemplary process 400 for generating a data post in a social media feed, generating a KC comment in a schedule activity kanban card, and/or generating a KC generated kanban card, in accordance with embodiments of the present invention.

FIG. 5 is an exemplary data flow diagram, in accordance with embodiments of the present invention.

FIG. 6 illustrates an exemplary plurality of display representations illustrating graphical user interface elements for displaying information related to project flows, in accordance with embodiments of the present invention.

FIG. 7 illustrates an exemplary plurality of display representations illustrating graphical user interface elements for displaying schedule information, including action recommendations and user assignments, in accordance with embodiments of the present invention.

FIG. 8 illustrates an exemplary plurality of display representations illustrating graphical user interface elements for displaying project activity cards, in accordance with embodiments of the present invention.

FIG. 9 illustrates an exemplary display representation illustrating graphical user interface elements for displaying planned versus actual milestone completions, in accordance with embodiments of the present invention.

FIG. 10 illustrates a block diagram of an exemplary electronic system, which may be used as a platform for embodiments of the present invention.

FIG. 11 illustrates an architectural computer-implemented integrated control system.

FIG. 12 illustrates a functional workflow and processing diagram for an integrated project control and analytics platform.

### DETAILED DESCRIPTION

Reference will now be made in detail to the various embodiments of the present disclosure, examples of which are illustrated in the accompanying drawings.

While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computing system. It has proven convenient at times, principally for reasons of common usage, to refer to these signals as transactions, bits, values, elements, symbols, characters, samples, pixels, or the like.

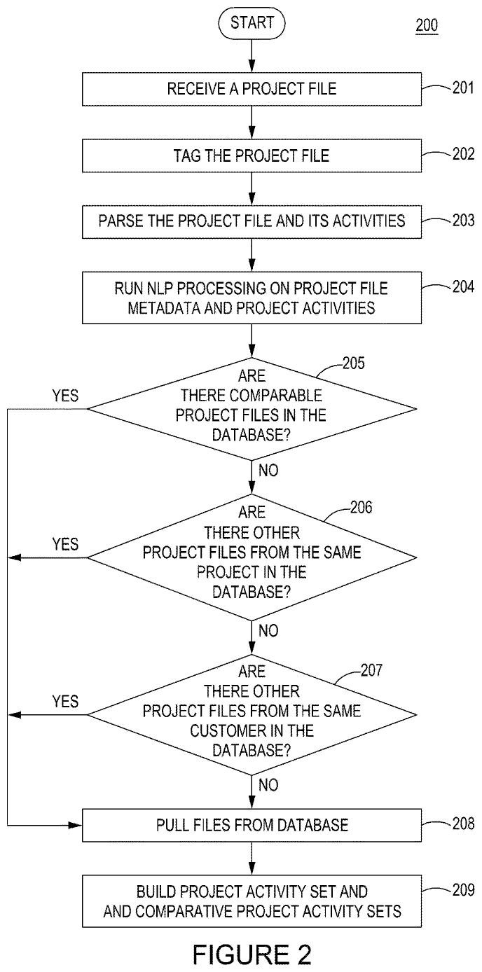

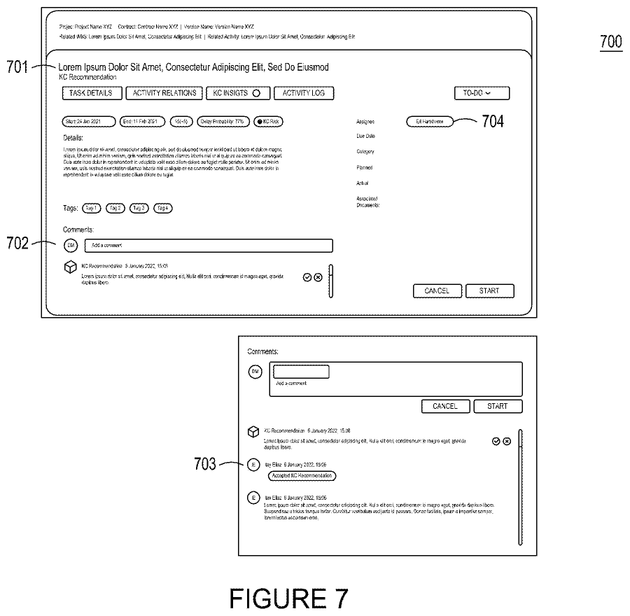

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “accessing,” “allocating,” “storing,” “receiving,” “sending,” “writing,” “reading,” “transmitting,” “loading,” “pushing,” “pulling,” “processing,” “caching,” “routing,” “determining,” “selecting,” “requesting,” “synchronizing,” “copying,” “mapping,” “updating,” “translating,” “generating,” “allocating,” or the like, refer to actions and processes of an apparatus or computing system (e.g., the methods of FIGS. 7, 8, 9, and 10) or similar electronic computing device, system, or network (e.g., the system of FIG. 2A and its components and elements). A computing system or similar electronic computing device manipulates and transforms data represented as physical (electronic) quantities within memories, registers or other such information storage, transmission or display devices.

Some elements or embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer storage media and communication media. Generally, program modules include routines, programs, objects, components, data structures, etc., that perform particular tasks or implement particular abstract data types. The functionality of the program modules may be combined or distributed as desired in various embodiments.

The meaning of “non-transitory computer-readable medium” should be construed to exclude only those types of transitory computer-readable media which were found to fall outside the scope of patentable subject matter under 35 U.S.C. § 101 in In re Nuijten, 500 F. 3d 1346, 1356-57 (Fed. Cir. 2007). The use of this term is to be understood to remove only propagating transitory signals per se from the claim scope and does not relinquish rights to all standard computer-readable media that are not only propagating transitory signals per se.

Computer storage media includes volatile and nonvolatile, removable and non-removable media implemented in any method or technology for storage of information such as computer-readable instructions, data structures, program modules, or other data. Computer storage media includes, but is not limited to, processor registers, double data rate (DDR) memory, random access memory (RAM), static RAMs (SRAMs), or dynamic RAMs (DRAMs), read only memory (ROM), electrically erasable programmable ROM (EEPROM), flash memory (e.g., an SSD) or other memory technology, compact disk ROM (CD-ROM), digital versatile disks (DVDs) or other optical storage, magnetic cassettes, magnetic tape, magnetic disk storage or other magnetic storage devices, or any other medium that may be used to store the desired information and that may be accessed to retrieve that information.

Communication media may embody computer-executable instructions, data structures, and/or program modules, and includes any information delivery media. By way of example, and not limitation, communication media includes wired media such as a wired network or direct-wired connection, and wireless media such as acoustic, radio frequency (RF), infrared and other wireless media. Combinations of any of the above may also be included within the scope of computer-readable media.

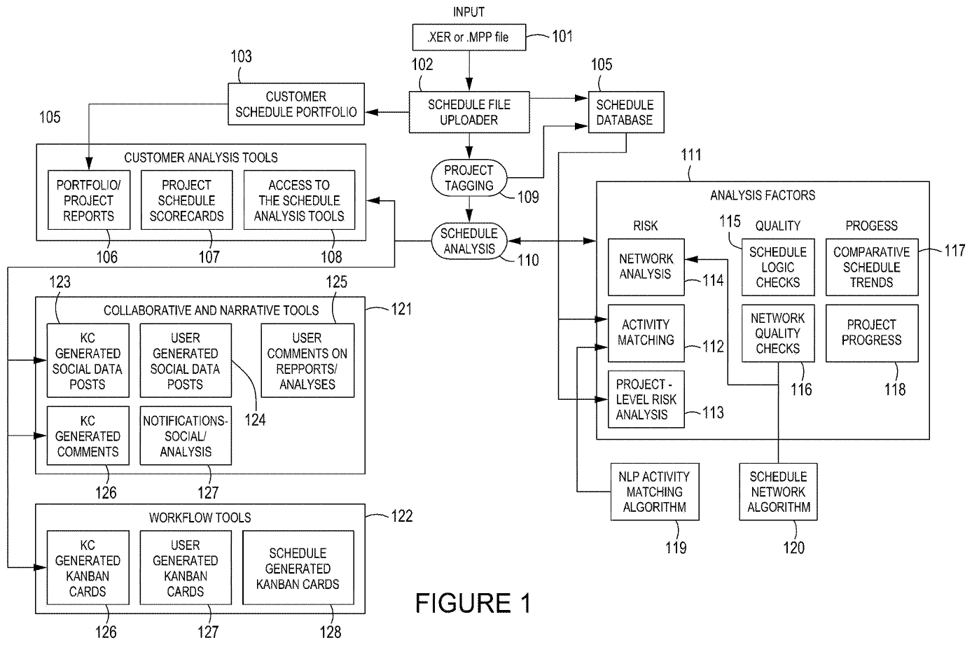

FIG. 1 illustrates a block diagram of an exemplary system 100 for visualizing and managing project flows, in accordance with embodiments of the present invention.

The following are some of the key steps involved in managing a megaproject. Clearly define the goals, objectives, and deliverables of the project, as well as any constraints and risks. Identify the individuals and organizations that will be involved in the project, and put together a project team with the right mix of skills, experience, and expertise. Create a comprehensive project plan that outlines the tasks, timelines, budgets, and resources required for the project, and ensure that all stakeholders are aware of and agree with the plan. Regularly monitor the progress of the project and compare it against the project plan. Make any necessary adjustments to ensure the project stays on track. Good communication is critical to the success of a megaproject. Ensure that all stakeholders are kept informed about the project status, progress, and any changes that may impact them. Identify, assess, and manage risks associated with the project, and put contingency plans in place to minimize their impact if they occur. Ensure that the project stays within budget and that resources are being used effectively. Regularly evaluate the performance of the project and make any necessary improvements. The success of a megaproject ultimately depends on effective leadership, strong project management skills, and the ability to effectively coordinate and collaborate with stakeholders. These steps are embodied in the process flow and block diagram of the megaproject manager as shown in FIG. 1.

The system and process is designed to, a) predict, b) detect, and c) track risks in megaproject construction programs, and related temporary organizations using novel algorithms and data analytics, presenting analyses through novel means, encouraging collaboration through social workflow tools such as action-based kanban cards, and social media-style data analysis posts.

The use of combinatory analytics across multiple present and past megaprojects to provide cross-project insights, and the manner in which these activities are tagged, matched, and analyzed gives the system the novel means of predicting and detecting risks across multiple facets of a megaproject, and across a range of verticals.

Megaprojects are at their core social endeavors, and the direction of key analytics and information towards a means of encouraging action and collaboration in a socialized environment, is both a novelty of the system, but also its primary drive.

Whilst workflow tools such as Kanban cards are ubiquitous across project management, these cards present a novel view of megaproject activities and their relationships as auto-generated action cards, to allow users to easily digest and track upcoming project tasks. A “Kanban card” is a physical or virtual card used in the Kanban method of project management. Kanban is a visual system that helps teams manage and improve their work processes by using a board with cards to represent work items and their current status. Each Kanban card typically represents a task, a work item, or a feature that needs to be completed. The card contains information about the task or item, such as a title, a brief description, and the person responsible for completing it. It may also include other relevant information, such as the due date, priority level, or any blockers that are preventing progress. Kanban cards are moved across the board as work progresses, with each column on the board representing a different stage in the workflow, from “To Do” to “In Progress” to “Done.” The movement of the cards helps teams visualize their work and identify areas where they can improve their processes to increase efficiency and productivity.

These are combined with novel algorithms as schedule recommendations presented as a visual representation of a work item, e.g., as “kanban cards,” auto-generated from novel ML algorithms and auto-assigned to specific users as trackable and collaborative action cards.

Wider collaborative tools are used to encourage users deeper into the knowledge base of their projects, with a view to increasing work efficiency and the dissemination of unbiased data throughout the group of users.

In one embodiment, an XER or . MPP file 101 is input to a computer system.

The XER or . MPP file 101 contains the data pertaining to one or more megaprojects.

The XER or . MPP file 101 is then uploaded by schedule file uploader 102 to a customer schedule portfolio 103 and a schedule database 104. The customer schedule portfolio contains data pertaining the desired schedule of a customer. The schedule database 104 tracks the schedule of the megaproject. The process flow from the customer schedule portfolio 103 proceeds to the customer analysis tools 105. These customer analysis tools 105 can include software to help analyze the customer's schedule information, such as a tool for portfolio and/or project reports 106; a tool for project schedule scorecards 107; and tools to access the schedule analysis 108.

Schedule file uploader 102 sends schedule data to the project tagging block 109, which tags the project for use in schedule database 104 and schedule analysis block 110. Schedule analysis block 110 exchanges data with analysis factors block 111. Schedule database 104 inputs schedule data to activity matching block 112 and project level risk analysis block 113 of analysis factors block 111. The analysis factors block 111 comprises risk, quality, and progress processes. The risk process includes activity matching 112, project level risk analysis 113, and network analysis 114. The quality process includes schedule logic checks 115 and network quality checks 116. The progress process includes the comparative schedule trends block 117 and the project progress block 118. A natural language processor activity matching algorithm 119 is used to input NLP data to the activity matching block 112 of the analysis factors 111. Data from a schedule network algorithm 120 is input to the network quality checks block 116 of the analysis factors 111 to determine quality factors. This data is also input to and used by the network analysis block 114 to determine risk factors.

The schedule analysis block 110 also inputs its data to the collaborative and narrative tools block 121 and the workflow tools block 122.

The collaborative and narrative tools 121 comprise five function blocks: Knowledge Center (KC) generated social data posts 123, user generated social data posts 124, user comments on reports/analyses 125, Knowledge Center generated comments 126, and notifications-social/analysis 127. The workflow tools 122 comprise Knowledge Center generated Kanban cards 126, user generated Kanban cards 127, and schedule generated Kanban cards 128.

FIG. 2 illustrates a flow chart of an exemplary process 200 for building project activity sets and comparative project activity sets, in accordance with embodiments of the present invention.

Process 200 builds datasets to create intra-project analytics using past comparable project data, and also customer portfolio project data, in some embodiments. The process starts by receiving a project file 201. The received project file is then tagged 202. The project file and its activities are then parsed 203. Natural language process (NLP) is then run on the project file metadata and project activities 204. A determination is made in step 205 as to whether there are comparable project files in the database. If there is at least one comparable project file that does exist in the database, the flow progresses to step 208. Otherwise, is there is not a comparable project file found in the database, step 206 is executed. In step 206, a determination is made as to whether there are other project files from the same project in the database. If there are other project files from the same project in the database, then the process flow proceeds to step 208. Otherwise, step 207 is performed. In step 207, a determination is made as to whether there are other project files from the same customer in the database. The process flow then proceeds to step 208. The appropriate files are pulled from the database in step 208. In step 209, the project activity set and comparative project activity sets are built.

As project files are added to a database, they are tagged across a number of key metrics and using project metadata. The system is then able to distinguish and group comparable projects to build a dataset for comparative analytics. Once this dataset is built, alongside the original project dataset, novel algorithms can be applied to build and present deep program insights to the user. In one embodiment, an artificial intelligence engine is trained and programmed with a prioritization algorithm. The Knowledge Center sorts thousands of things a user could be doing into focused priorities of what each team needs to be working on in the coming week, month and quarter to achieve speedy results. An AI prioritization algorithm is a type of machine learning algorithm that uses artificial intelligence techniques to prioritize a set of items or tasks based on certain criteria or objectives. The algorithm works by analyzing a set of data related to the items or tasks, such as their importance, urgency, or other characteristics. The algorithm then uses this data to determine the priority order for each item or task. There are various types of AI prioritization algorithms, such as decision trees, neural networks, and reinforcement learning algorithms. These algorithms are applied to prioritize the thousands of tasks associated with managing a megaproject.

The Knowledge Center platform comprises automated reporting and narratives, AI-driven prioritization and recommendations, risk prediction and control, collaboration and workflow, and excellence applications. Using the Knowledge Center entails obtaining a domain and uploading the user's Primavera P6 or Microsoft Project files.

The Knowledge Center then generates insights instantaneously which the team can then act upon. AI calculated scorecards display progress, risk, and quality graphs and a risk look ahead chart. AI-prioritized battlecards display Kanban cards related to To Do, In Progress, and Done activities. A priorities Matrix show weekly priorities labeled as Urgent (Do Now/Delegate) and Not Urgent (Do Next/Later). The prioritization engine is an AI engine with a prioritization algorithm that sorts thousands of things a user could be doing into focused priorities of what each team needs to be working on in the coming week, month, and quarter to achieve speedy results. A collaboration and personalized workflow is generated. Each program activity automatically becomes a Knowledge Center battlecard. Everything a user needs to know to get it done is shown in one convenient location. It is sequenced and prioritized according to the user's inputs. Users can collaborate, assign, share, comment, tag and track progress across all teams. Users can also invite external parties with role-based access control to focus on specific work. Users can also view their entire portfolio on one screen, risks and bottlenecks included.

The wins are displayed as well as the issues. Lessons learned and risks from across the portfolio become recommendations and alerts for in-flight projects. The Knowledge Center also provides teams with the highest level of insight into their schedule data. The Knowledge Center reveals what will happen in the future and suggests what teams should do about it. In one embodiment, an AI future risk prediction algorithm is comprised of a type of machine learning algorithm that uses artificial intelligence techniques to analyze data and predict the likelihood of future risks or negative events that may occur during construction of the megaproject. These algorithms work by analyzing historical data and identifying patterns or correlations that are indicative of potential risks or negative events in the future. The algorithm learns from the current, past, or other related megaprojects and uses this data as a training set to make the future predictions on the current megaproject management.

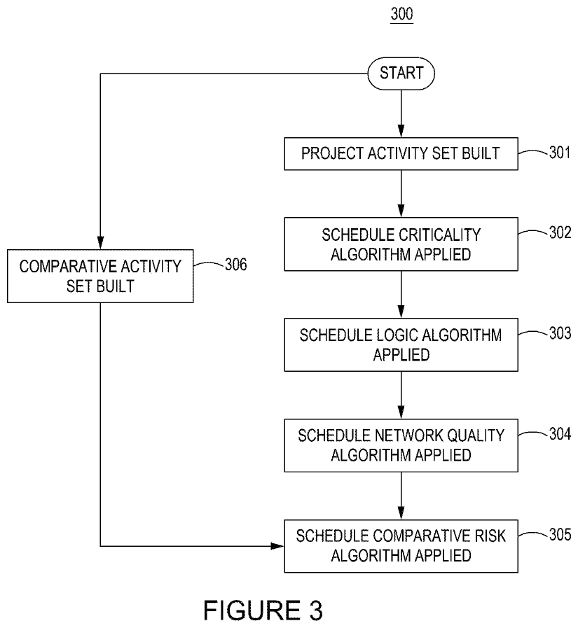

FIG. 3 illustrates a flow chart of an exemplary process 300 for scheduling comparative risk, in accordance with embodiments of the present invention. In step 301, the project activity set is built. The schedule criticality algorithm is then applied in step 302. A schedule logic algorithm is applied in step 303. Another algorithm, the schedule network quality algorithm, is applied in step 304. A schedule comparative risk algorithm is applied in step 305. Overall, a comparative activity set is built, step 306.

Once the relevant datasets have been built, a number of novel algorithms are applied, examples of which are illustrated, in some embodiments. These algorithms determine certain risks in the program, using mathematical and logical specifications, and are used in both a composite and singular manner throughout the tool.

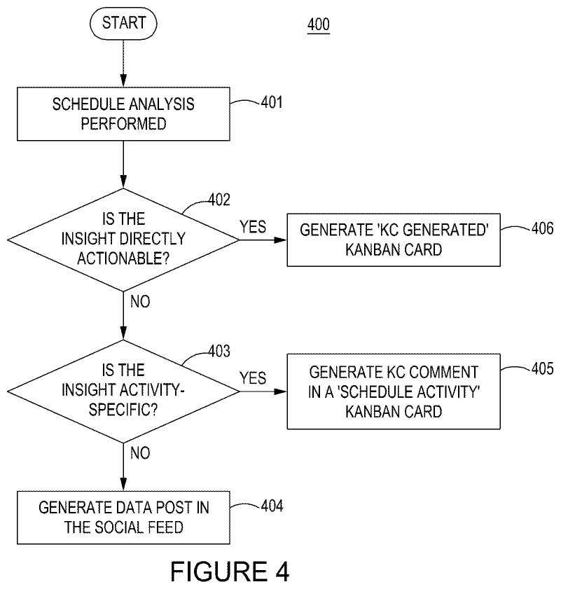

FIG. 4 illustrates a flow chart of an exemplary process 400 for generating a data post in a social media feed, generating a KC comment in a schedule activity kanban card, and/or generating a KC generated kanban card, in accordance with embodiments of the present invention. Initially, in step 401, a schedule analysis is performed. Based on the schedule analysis, a determination is made as to whether the insight is directly actionable, step 402. If the insight is directly actionable, the process flow proceeds to step 406.

Otherwise, if the insight is not directly actionable, a determination is made as to whether the insight is activity specific, step 403.

Once the system has run the algorithms and determined the analysis to be presented, it is then determined which novel method to present this analysis in.

If the insight produced can be directly and immediately acted upon by a user, it may be presented as an auto-generated trackable action card with a specific recommendation from the system describing means of alleviating the associated risks.

If the insight relates to a specific program activity but is not necessarily directly actionable, it is presented as an auto-generated comment within an action card. The owner of any activity will be alerted to the risk via the comment, and other users can collaboratively work on the issue through the card.

If the insight is not related to a specific program activity, nor is it directly actionable, it can be presented as a data post in a social media-style feed. This insight can then be discussed by users, and presented to stakeholders and other information consumers across the program.

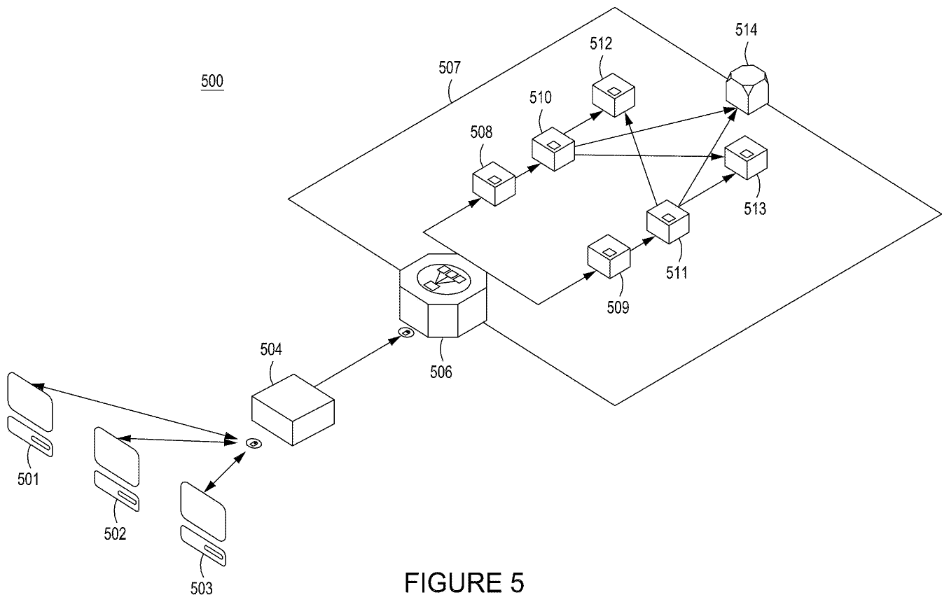

FIG. 5 is an exemplary data flow diagram 500, in accordance with embodiments of the present invention. A set of computers 501-503 access Cloudflare 504, a global network designed to make everything connected to the Internet secure, private, fast, and reliable. Cloudflare 504 is coupled to a load balancer 505, which is part of a virtual private cloud, VPC 507. The VPC 507 is a secure, isolated private cloud hosted within a public cloud. VPC customers can run code, store data, host websites, and do anything else they could do in an ordinary private cloud, but the private cloud is hosted remotely by a public cloud provider. VPC 507 combines the scalability and convenience of public cloud computing with the data isolation of private cloud computing. VPC 507 comprises at least two web servers 508 and 509; two application servers 510 and 511; two artificial intelligence/machine learning servers (AI/ML) 512 and 513; and a relational database service (RDS) database 514.

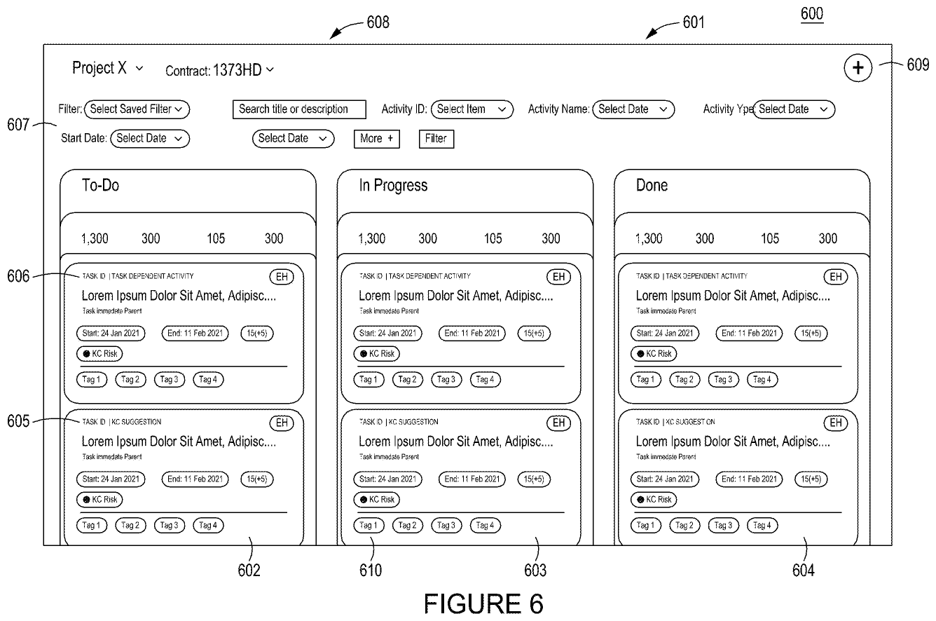

FIG. 6 illustrates an exemplary plurality of display representations 600 illustrating graphical user interface elements for displaying information related to project flows, in accordance with embodiments of the present invention. An exemplary Knowledge Center board 601 is shown. A “Kanban board is a visual tool used in the Kanban method of project management to represent work items and their current status.

The board typically consists of a physical or digital surface with columns and cards representing different stages of the workflow. The columns on a Kanban board can vary depending on the specific needs of a team, but typically include at least three columns: “To Do,” “In Progress,” and “Done.” The cards on the board represent the work items that need to be completed, and each card contains relevant information such as the title, description, due date, and the person responsible for the task. As work progresses, cards are moved across the board from one column to the next. For example, a card may start in the “To Do” column 602 and move to the “In Progress” column 603 when work begins, and then to the “Done” column 604 when the task is completed. This visual representation of work helps teams better understand their workflow and identify areas for improvement to increase efficiency and productivity. Kanban boards can be created using software tools, such as Trello or Asana.

In particular, Knowledge Center generated suggestion cards 605 comprise action items based on Knowledge Center algorithms. Project activity cards 606 can be used to collaborate on project activities. In one embodiment, users will see pre-filtered cards that are relevant to them and their roles 607. Users can also filter cards across a wide range of attributes, allowing them to use the cards in a range of scenarios, such as daily project update meetings, regular stakeholder meetings, etc. 608. Users can create their own cards to capture workflow meeting action items or action items they feel would benefit the project and assign them to the correct user 609. Colors are used to highlight potential risks and issues, such as a card not being moved at the times it should have been, according to plans 610. In one embodiment, the top portion of the Kanban board includes menus such as a filter option, start date, end date, search field, activity ID, activity name, and activity type.

FIG. 7 illustrates an exemplary plurality of display representations 700 illustrating graphical user interface elements for displaying schedule information, including action recommendations and user assignments, in accordance with embodiments of the present invention. The schedule quality/risk/progress issue(s) to be resolved is shown in 701. The action item/recommendation based on schedule analyses to resolve this issue is shown as 702. Users can accept or decline Knowledge Center suggestions based on whether they feel they are useful or not, 703. The card is auto-assigned to the most relevant user, but can be reassigned by them, if needed, 704.

In one embodiment, the top of the graphical user interface includes information related to the project, the contract, the version name, the related work breakdown structure (WBS), and the related activity. Users may click on buttons to traverse to a different page, such as Task Details, Activity Relations, KC Insights, and Activity Log. The Start Time, End Time, number of comments, Delay Probability, and KC Risk data are also display for view.

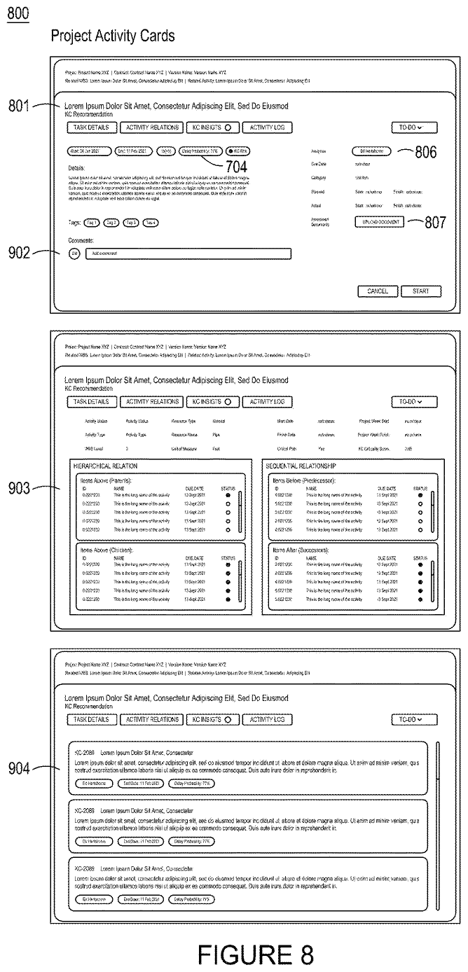

FIG. 8 illustrates an exemplary plurality of display representations 800 illustrating graphical user interface elements for displaying project activity cards, in accordance with embodiments of the present invention. Display representations 800 illustrate a variety of information generated and/or provided in project activity cards, including social collaboration among teams, activity relationships among a variety of parties, KC recommendations, contact information for responsible parties, and/or supplemental information about a variety of activities, in accordance with embodiments of the present invention.

In one embodiment, information is taken from the project schedule .xer/.mpp files, as shown by 801. Comments allow for social collaboration between teams. Information transfer about an activity is held within that activity's card, 802. Highlighting the activity relationships within the schedule network assists with highlighting blockers to an activity, and the potential activities that could be blocked by this one, 803. A list of KC Recommendation cards that are related to the program activity are displayed to the user, 804. The action items found in the analysis that would improve performance of this activity are consolidated to include all other activities that have this same issue, 804. Activity delay probabilities based on the Activity Matching algorithms are displayed, 805. In 806, responsible people who can be contacted if problems arise are displayed. Supplementary information about the activity is also held within the activity's card, 807. Documentation can be uploaded by users to support the completion of the activity.

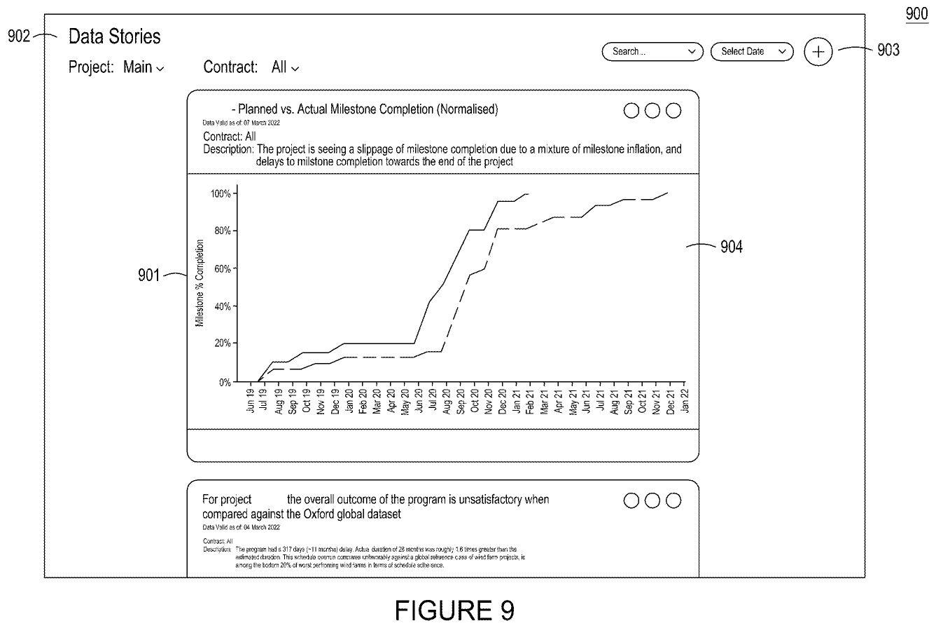

FIG. 9 illustrates an exemplary display representation 900 illustrating graphical user interface elements for displaying planned versus actual milestone completions, in accordance with embodiments of the present invention. The information is presented in a graphical representation whereby the X-axis represents time passage, and the Y-axis represents milestone complete percentage. One graph charts the actual milestone completion as a function of time passing and the other graph charts the planned completion as a function of time passing. One can quickly glance at this chart to see the past, present, and future delays (or completions ahead of schedule). In one embodiment, interactive and collaborative data posts can be used to present non-actionable or general analysis of the project or portfolio, 901. Data Stories and Posts present analyses in easy-to-digest “social media” style posts, allowing for discussion on certain aspects of the project, 902. Users can add their own data stories linking to analyses from throughout the tool to highlight specific information to their colleagues for discussion, 903. These can also be used to present stakeholder reports in an interactive and detailed manner, with all the data coming directly from the central database rather than having to manually collate the data, as shown by 904.

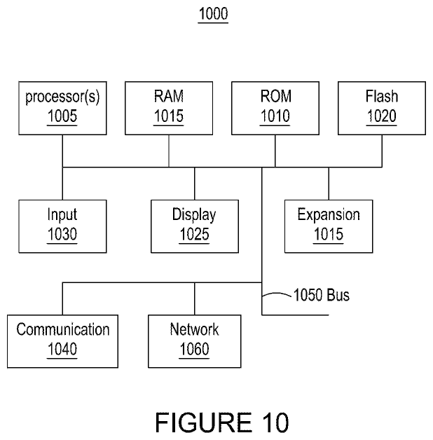

FIG. 10 illustrates a block diagram of an exemplary electronic system 1000, which may be used as a platform for embodiments of the present invention.

Electronic system 1000 may be a hand-held, e.g., a “smart” phone, tablet, portable, or “server” computer system, in some embodiments. Electronic system 1000 includes an address/data bus 1050 for communicating information, a central processor complex 1005 functionally coupled with the bus for processing information and instructions. Bus 1050 may comprise, for example, a Peripheral Component Interconnect Express (PCIe) computer expansion bus, industry standard architecture (ISA), extended ISA (EISA), MicroChannel, Multibus, IEEE 796, IEEE 1196, IEEE 1496, PCI, Computer Automated Measurement and Control (CAMAC), MBus, Runway bus, Compute Express Link (CXL), and the like.

Central processor complex 1005 may comprise a single processor or multiple processors, e.g., a multi-core processor, or multiple separate processors, in some embodiments. Central processor complex 1005 may comprise various types of well-known processors in any combination, including, for example, digital signal processors (DSP), graphics processors (GPU), complex instruction set (CISC) processors, reduced instruction set (RISC) processors, and/or very long word instruction set (VLIW) processors. In some embodiments, exemplary central processor complex 1005 may comprise a finite state machine, for example, realized in one or more field programmable gate array(s) (FPGA), which may operate in conjunction with and/or replace other types of processors to control embodiments in accordance with the present invention.

Electronic system 1000 may also include a volatile memory 1015 (e.g., random access memory RAM) coupled with the bus 1050 for storing information and instructions for the central processor complex 1005, and a non-volatile memory 1010 (e.g., read only memory ROM) coupled with the bus 1050 for storing static information and instructions for the processor complex 1005. Electronic system 1000 also optionally includes a changeable, non-volatile memory 1020 (e.g., NOR flash) for storing information and instructions for the central processor complex 1005 which can be updated after the manufacture of system 1000. In some embodiments, only one of ROM 1010 and/or Flash 1020 may be present.

Also included in electronic system 1000 of FIG. 10 is an optional input device 1030. Input device 1030 can communicate information and command selections to the processor complex 1005. Input device 1030 may be any suitable device for communicating information and/or commands to the electronic system 1000. For example, input device 1030 may take the form of a keyboard, buttons, a joystick, a track ball, an audio transducer, e.g., a microphone, a touch sensitive digitizer panel, eyeball scanner, and/or the like.

Electronic system 1000 may comprise a display unit 1025. Display unit 1025 may comprise a liquid crystal display (LCD) device, cathode ray tube (CRT), field emission device (FED, also called flat panel CRT), light emitting diode (LED), plasma display device, electro-luminescent display, electronic paper, electronic ink (e-ink) or other display device suitable for creating graphic images and/or alphanumeric characters recognizable to the user. Display unit 1025 may have an associated lighting device, in some embodiments.

Electronic system 1000 also optionally includes an expansion interface 1035 coupled with the bus 1050. Expansion interface 1035 can implement many well known standard expansion interfaces, including without limitation the Secure Digital Card interface, universal serial bus (USB) interface, Compact Flash, Personal Computer (PC) Card interface, CardBus, Peripheral Component Interconnect (PCI) interface, Peripheral Component Interconnect Express (PCI Express), mini-PCI interface, IEEE 1394, Small Computer System Interface (SCSI), Personal Computer Memory Card International Association (PCMCIA) interface, Industry Standard Architecture (ISA) interface, RS-232 interface, and/or the like. In some embodiments of the present invention, expansion interface 1035 may comprise signals substantially compliant with the signals of bus 1050.

A wide variety of well-known devices may be attached to electronic system 1000 via the bus 1050 and/or expansion interface 1035. Examples of such devices include without limitation rotating magnetic memory devices, flash memory devices, digital cameras, wireless communication modules, digital audio players, and Global Positioning System (GPS) devices.

System 1000 also optionally includes a communication port 1040.

Communication port 1040 may be implemented as part of expansion interface 1035.

When implemented as a separate interface, communication port 1040 may typically be used to exchange information with other devices via communication-oriented data transfer protocols. Examples of communication ports include without limitation RS-232 ports, universal asynchronous receiver transmitters (UARTs), USB ports, infrared light transceivers, ethernet ports, IEEE 1394, and/or synchronous ports.

System 1000 optionally includes a network interface 1060, which may implement a wired or wireless network interface, for example, mobile and/or cellular data and/or telephony, “WiFi” and/or IEEE 802.11 interfaces,. Electronic system 1000 may comprise additional software and/or hardware features (not shown) in some embodiments.

Various modules of system 1000 may access computer readable media, and the term is known or understood to include removable media, for example, Secure Digital (“SD”) cards, CD and/or DVD ROMs, diskettes and the like, as well as non-removable or internal media, for example, hard drives, solid state drive s (SSD), RAM, ROM, flash, and the like.

Embodiments of the present invention relate to computer-implemented systems and methods for controlling time, risk, and delivery outcomes in complex infrastructure projects using artificial intelligence-driven schedule computation and predictive modeling. The embodiments described below are directed to specific technological improvements and innovations in the operation of project control computing systems by enabling continuous, machine-executed transformation of heterogeneous project data into a unified, dynamically updated temporal model.

Conventional project management systems rely on static schedules that are manually authored, periodically updated, and retrospectively analyzed. Such systems suffer from technical limitations including data fragmentation, update latency, and inability to computationally propagate changes across interconnected project dimensions. The present invention overcomes these limitations by treating project time as a first-class computable entity and by executing continuous schedule re-computation using trained models, graph-based dependency structures, and probabilistic simulation engines.

In one embodiment, the system maintains an owner-controlled Integrated Master Schedule stored in non-transitory memory and represented as a directed temporal dependency graph. Nodes of the graph correspond to activities, milestones, procurement events, or physical work packages, and edges represent temporal, logical, or resource-based dependencies. The Integrated Master Schedule is generated, validated, and continuously regenerated by a coordinating computing system operating independently of contractor-authored schedules. The system enforces the Integrated Master Schedule as the authoritative temporal data structure used for milestone forecasting, simulation, and portfolio-level computation.

The system implements a centralized control tower computing architecture in which a processor executes ingestion pipelines that normalize and synchronize heterogeneous data inputs, including design models, schedule files, procurement records, logistics data, site imagery, and execution updates. These inputs are transformed into machine-readable feature vectors and graph updates that are written into a shared temporal data store. By operating on a unified temporal data structure, the system ensures that schedule logic, procurement commitments, and physical progress updates are computationally consistent and temporally aligned.

In various embodiments, the system performs generative schedule construction by deriving schedule activities and dependencies directly from physical scope representations rather than relying on manually enumerated activity lists. Three-dimensional design models are processed to extract quantities, spatial relationships, and workfaces, which are then mapped to executable activities using trained productivity and sequencing models. The processor generates multiple feasible schedule instances by applying constraint solvers and optimization routines that account for labor availability, equipment constraints, supply availability, and shift patterns. These schedule instances are stored as alternative temporal graph configurations rather than as static baseline files.

As new execution data is ingested, the system automatically performs in-flight regeneration of the Integrated Master Schedule by updating graph nodes, recomputing dependency paths, and recalculating milestone forecasts. Evidence-based progress validation is performed by comparing planned scope representations against observed site conditions derived from imagery analysis or sensor inputs. Deviations are detected algorithmically, and the computer system computes recovery or acceleration scenarios by generating and evaluating alternative graph configurations rather than issuing passive notifications.

In further embodiments, the system enforces a technical separation between owner-controlled temporal computation and contractor-controlled execution planning.

Contractor-provided schedules may be ingested as auxiliary data sources, but write access to the authoritative temporal graph is restricted by role-based controls. The system allows contractors to submit proposed dependency changes or sequencing alternatives, which are evaluated by the processor using rule-based validation and predictive impact analysis prior to acceptance. This preserves schedule governance while enabling structured collaboration without duplicating or fragmenting temporal data.

In additional embodiments, the system integrates procurement and supply-chain events as time-indexed nodes within the temporal dependency graph. Purchase orders, fabrication milestones, shipment events, and delivery confirmations are stored as discrete temporal objects with defined dependency relationships to construction activities. When a procurement event changes state, the processor propagates the temporal effect through the dependency graph and recomputes milestone forecasts in computational time units.

This enables deterministic calculation of schedule impact rather than qualitative status reporting.

The system further employs artificial intelligence models that treat the temporal graph as a probabilistic system. Machine learning models trained on historical project data estimate uncertainty distributions for activity durations, dependency strength, and delay propagation. The processor executes stochastic simulations, including Monte Carlo-based schedule risk analysis, directly on the temporal graph to generate probability distributions for milestone completion dates. Graph-based learning techniques identify structurally critical nodes whose perturbation disproportionately affects downstream outcomes.

In one embodiment, computer vision models process site imagery and three-dimensional capture data to classify installed versus planned scope elements. The results of image inference are converted into structured progress updates that directly modify node state within the temporal graph. Reinforcement learning models are used to evaluate historical intervention outcomes and to rank candidate schedule adjustments based on predicted effectiveness under current conditions.

In further embodiments, the system provides a low-latency computational query interface that allows users to issue natural-language requests. The processor translates such requests into structured graph queries and simulation commands, executes the corresponding computations, and returns responses derived from live schedule models rather than static reports. This enables real-time exploration of delivery confidence, tradeoffs, and downside risk without manual analytical workflows.

The disclosed invention improves the functioning of project control computing systems by reducing data inconsistency, minimizing update latency, enabling automated propagation of temporal changes, and providing computationally derived recovery strategies. The system transforms disparate data sources into a continuously updated temporal model, executes predictive simulations using trained models and graph-based algorithms, and produces machine-generated outcomes that were not previously achievable using conventional project management software.

By enabling continuous computational control of project time through specific data structures, processing pipelines, and artificial intelligence models, the invention provides a technological solution to the technical problem of predicting and controlling delivery outcomes in complex infrastructure environments where time-to-market has measurable operational and financial consequences.

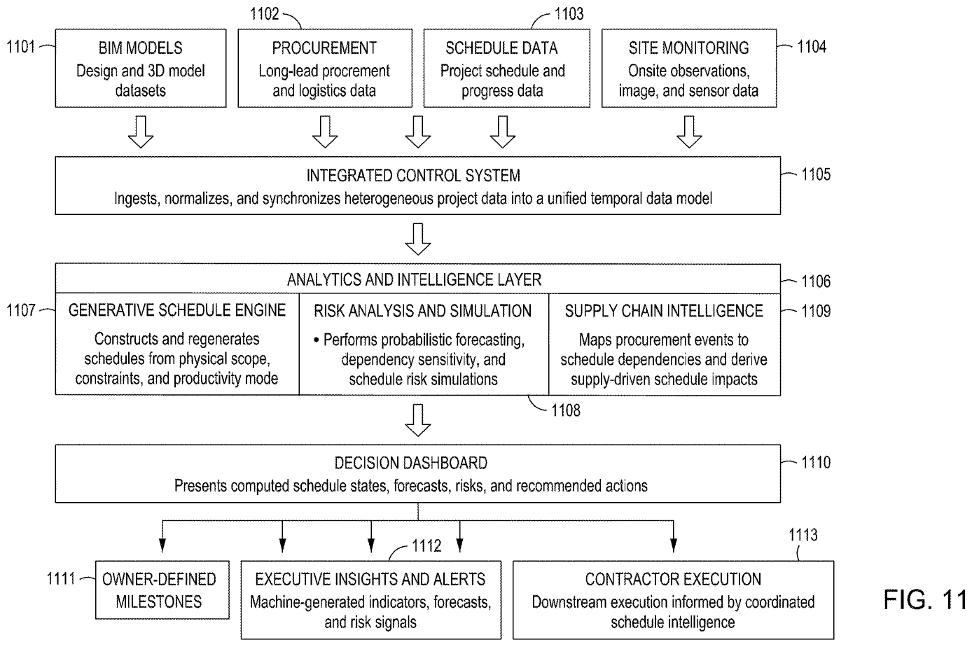

FIG. 11 illustrates an architectural computer-implemented integrated control system composed of a plurality of functional blocks that cooperate to transform heterogeneous project data into a unified temporal data model and to generate machine-derived schedule states, forecasts, risks, and recommended actions for managing complex infrastructure and megaprojects.

The BIM Models block 1101 provides design and three-dimensional model datasets generated by architectural, engineering, and construction design systems. These datasets encode physical scope information, spatial relationships, quantities, and constructability attributes. The BIM Models block outputs structured representations of physical elements that are parsed by the system to extract work packages, spatial dependencies, and scope attributes. These extracted elements are converted into machine-readable data objects that can be temporally linked to schedule activities and dependency structures downstream.

The Procurement block 1102 provides long-lead procurement and logistics data associated with materials, equipment, and prefabricated components required for project execution. This block supplies time-based signals including procurement commitments, fabrication milestones, shipping events, and delivery confirmations. Rather than being treated as static records, the procurement data is structured as temporal constraint inputs that are later mapped to schedule dependencies, allowing supply availability and delay conditions to directly influence computed schedule outcomes.

The Schedule Data block 1103 supplies project schedules and progress data, including activity definitions, durations, logical relationships, baseline states, and execution updates. This block defines the initial temporal structure of the project by providing activity networks that specify precedence relationships and planned execution sequences. Progress updates supplied through this block modify activity state variables that reflect actual execution conditions over time.

The Site Monitoring block 1104 provides onsite observations, image, and sensor data generated by cameras, scanners, drones, or embedded sensing devices. This block supplies objective, time-stamped evidence of physical execution state. The system uses this data to validate, corroborate, or correct planned progress represented in the Schedule Data block by associating observed physical conditions with corresponding activities or work packages in the temporal model.

The Integrated Control System block 1105 ingests, normalizes, and synchronizes heterogeneous project data into a unified temporal data model. This block performs concrete computing operations including schema translation, time alignment, dependency reconciliation, and version management across all incoming data streams. The Integrated Control System constructs and maintains a machine-readable temporal graph in which activities, procurement events, and physical progress signals are represented as nodes and edges with explicit time semantics. Conflicting or asynchronous updates are resolved using rule-based reconciliation logic, and successive states of the temporal model are preserved as versioned representations to enable deterministic re-computation and traceability. This block enforces a single authoritative temporal representation that prevents divergence between design scope, supply chain conditions, schedule logic, and physical execution.

The Analytics and Intelligence Layer 1106 is comprised of the Generative Schedule Engine 1107, the Risk Analysis and Simulation block 1108, and the Supply Chain Intelligence block 1109.

The Generative Schedule Engine block 1107 operates on the unified temporal data model to construct and regenerate schedules based on physical scope, constraints, and productivity parameters. This block computes feasible activity sequences by evaluating dependency structures and constraint satisfaction conditions rather than relying solely on manually authored activity lists. When upstream inputs such as procurement events, design changes, or progress updates modify the temporal model, the Generative Schedule Engine recomputes schedule states to reflect current execution reality and produces updated activity networks representing alternative feasible execution paths.

The Risk Analysis and Simulation block 1108 performs probabilistic forecasting and dependency sensitivity analysis on the temporal graph maintained by the Integrated Control System. This block applies stochastic modeling techniques to compute completion probability distributions for activities and milestones based on factors such as float sensitivity, network topology, historical variance, and interdependency density. The block identifies structural risk concentrations and computes how delays or accelerations propagate through the dependency network, generating machine-derived risk metrics and forecast confidence levels. In the context of the disclosed invention, dependency sensitivity refers to a quantitatively computed measure of how changes in the execution state or duration of one activity propagate through a temporal dependency network to affect downstream activities, milestones, or overall project completion outcomes.

Dependency sensitivity is not a static attribute and is not limited to binary critical path classification. Instead, it is computed dynamically by one or more processors operating on the authoritative temporal data structure maintained by the system. In the context of monitoring mega projects, dependency sensitivity forecasting comprises a multidimensional analytical framework configured to evaluate and predict system output variances by accounting for the inherent interdependencies and stochastic correlations between a plurality of input variables. This methodology utilizes dependency networks and global sensitivity algorithms to characterize how simultaneous shifts in correlated parameters, such as the co-movement of logistical schedules and budgetary allocations, propagate through a predictive model. By integrating techniques such as Monte Carlo simulations and directional influence mapping, the system identifies critical nodes within a project structure that exert a disproportionate impact on the final output. The method further enhances the robustness of the forecast by quantifying cascading effects and interaction risks that remain latent in isolated variable testing, thereby providing a comprehensive probabilistic range for complex system behavior under varying operational stressors. This framework enables the generation of real-time predictive alerts based on detected risk propagation, allowing for the prioritization of mitigation efforts based on a parameter's potential to impact non-adjacent project phases.

In the foregoing embodiments, temporal relationships between activities and milestones are described using a directed dependency graph. In alternative embodiments, the temporal data structure is implemented using other representations that encode precedence and dependency information without being explicitly instantiated as a graph object. For example, dependencies may be represented using relational database tables in which activity records include predecessor and successor identifiers, or using constraint sets in a scheduling solver in which each constraint encodes a temporal relationship between activities. In such embodiments, operations described herein as graph traversal or path enumeration are implemented as iterative queries or solver operations over the underlying temporal representation. Dependency sensitivity may be computed using these non-graph representations by repeatedly identifying successor activities reachable from a selected activity, evaluating slack and milestone importance along such successor chains, and aggregating numerical influence values, thereby producing a dependency sensitivity score without requiring an explicit graph data structure.

In one example, the system stores for each activity a list of successor activity identifiers and an associated slack value to a completion milestone. To compute a dependency sensitivity score for a selected activity A, the system iteratively follows successor lists to identify downstream chains to milestones, computes a path influence value for each chain based on chain length, slack, and milestone weight, and sums or otherwise aggregates the path influence values into a raw sensitivity value. The raw value is then normalized into a bounded score and stored in association with activity A. This procedure yields a dependency sensitivity score using successor lists and slack values without constructing an explicit node-edge graph object The system represents project time as a directed dependency graph in which nodes correspond to activities or milestones and edges represent temporal, logical, or resource-based dependency relationships. Dependency sensitivity is computed by evaluating the structural position of a given node within the directed dependency graph and determining the extent to which perturbations to that node's state variables influence downstream nodes and milestone completion states.

In some embodiments, dependency sensitivity is computed by algorithmically traversing the directed dependency graph to identify downstream paths originating from a given activity and evaluating attributes of those paths, including path length, branching density, slack availability, and convergence at critical milestones. Activities that lie upstream of multiple dependency paths or that converge at high-priority milestones are assigned higher dependency sensitivity values than activities with limited downstream influence.

Dependency sensitivity further accounts for dynamic execution state by incorporating activity state variables such as remaining duration, progress rate, and variance from planned execution. When an activity transitions between execution states or exhibits duration consumption variance, the system recomputes dependency sensitivity to reflect the updated propagation risk within the dependency network.

In some embodiments, dependency sensitivity incorporates probabilistic factors derived from historical execution data. Machine learning models trained on prior project datasets estimate how delays or accelerations in similar dependency configurations have historically propagated through comparable networks. These learned propagation tendencies are combined with graph-based metrics to compute a dependency sensitivity score that reflects both structural and empirical risk.

Unlike conventional critical path methods that classify activities as either critical or non-critical, dependency sensitivity expresses a continuous value representing the computed responsiveness of downstream outcomes to changes in a given activity. This allows the system to distinguish between activities that may not currently lie on a critical path but nevertheless exhibit high potential to cause downstream delay due to low float elasticity, dense dependency coupling, or proximity to milestone convergence points.

The computed dependency sensitivity values are used by the system in multiple computational processes. In progress analytics, dependency sensitivity is applied as a weighting factor such that activities with higher downstream impact contribute proportionally more to aggregate progress metrics. In risk assessment, dependency sensitivity contributes to criticality scoring and risk density modeling, enabling identification of regions within the dependency graph where delay propagation risk is concentrated. In completion forecasting, dependency sensitivity influences probabilistic outcome distributions by modifying uncertainty bounds associated with affected milestones.

By computing dependency sensitivity as a dynamic, algorithmic property of a directed dependency graph rather than as a static planning classification, the disclosed system enables continuous, machine-driven assessment of how local execution changes affect global delivery outcomes. This capability improves the functioning of project scheduling computers by enabling earlier detection of latent risk, more accurate forecasting, and targeted intervention based on quantified propagation behavior rather than subjective judgment.

The Supply Chain Intelligence block 1109 maps procurement events to schedule dependencies and derives supply-driven schedule impacts. This block algorithmically links procurement milestones provided by the Procurement block to downstream construction activities in the temporal graph. When procurement events change state, such as through delay or early delivery, the Supply Chain Intelligence block propagates the resulting temporal impact through dependent activities and milestones. This allows the system to compute schedule exposure and execution risk attributable specifically to supply chain conditions without manual analysis.

The Decision Dashboard block 1110 presents computed schedule states, forecasts, risks, and recommended actions generated by the analytical blocks. The Decision Dashboard operates as an interface to the underlying temporal computation engine and renders machine-generated outputs rather than raw source data. The dashboard enables users to interrogate predictive outcomes, scenario results, and risk signals derived from algorithmic processing, supporting low-latency decision-making and intervention.

The Owner-Defined Milestones block 1111 represents authoritative delivery targets and constraints established by the project owner. These milestones are encoded into the temporal data model and serve as boundary conditions for schedule generation, risk evaluation, and scenario analysis. The system evaluates computed schedule states against these milestones to determine compliance, forecast deviation, and delivery confidence.

The Executive Insights and Alerts block 1112 generates automated indicators and alerts based on computed deviations, forecast deterioration, or threshold crossings detected within the temporal model. These insights are produced by algorithmic evaluation of schedule states and risk metrics rather than by manual reporting, ensuring consistent and repeatable signaling of conditions requiring executive attention.

The Contractor Execution block 1113 represents downstream execution activities informed by coordinated schedule intelligence generated by the system. Outputs delivered to this block are aligned with the authoritative temporal model, enabling contractors to coordinate execution with owner-defined milestones and supply-driven constraints while retaining autonomy over means and methods. This separation preserves governance integrity while enabling coordinated execution across multiple parties.

Collectively, the blocks illustrated in FIG. 11 operate as a specialized computing system that transforms fragmented project data into a continuously synchronized temporal computation engine. By enabling automated dependency propagation, real-time recomputation of schedule states, and predictive control of execution outcomes, the system improves the functioning of project management computer systems and integrates the claimed subject matter into a practical application that produces concrete, machine-generated control signals rather than abstract management concepts.

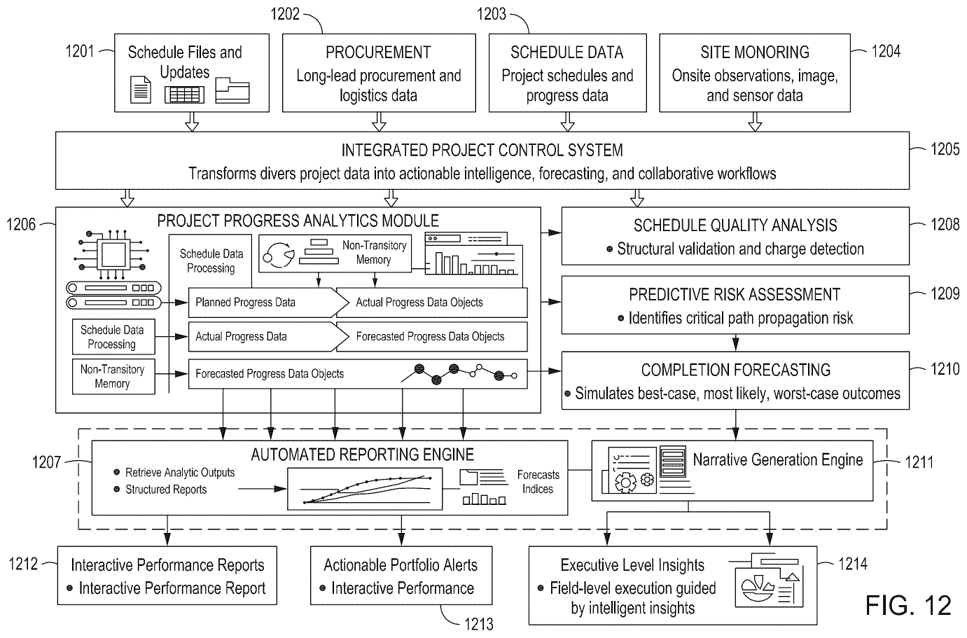

FIG. 12 illustrates a functional workflow and processing diagram for an integrated project control and analytics platform. The diagram shows multiple heterogeneous project data inputs, including schedule files and updates, procurement data, schedule and progress data, and site monitoring data, flowing into an integrated project control system that transforms the incoming data into actionable intelligence. The integrated system feeds a project progress analytics module that computes planned, actual, and forecasted progress states, which in turn support schedule quality analysis, predictive risk assessment, and completion forecasting. Outputs from these analytic functions are consumed by an automated reporting engine and a narrative generation engine to produce structured reports, alerts, and executive-level insights, enabling portfolio-level visibility and informed decision-making across complex projects.

The system receives machine-readable schedule artifacts through a schedule files and updates interface 1201 that accepts baseline schedules and subsequent revisions encoding activities, milestones, durations, constraints, and dependency relationships. These schedule artifacts are parsed to extract structured representations of temporal elements, including activity identifiers, logical relationships, and sequencing attributes. The extracted data is transmitted to the integrated project control system 1205, where it establishes or modifies the authoritative temporal representation used throughout the system. By operating directly on machine-readable schedule structures rather than static reports, the system enables automated detection of timing changes, logic modifications, and scope adjustments that serve as triggers for downstream re-computation.

In parallel, long-lead procurement and logistics data is ingested through a procurement interface 1202 that receives supply-side temporal events such as order placement, fabrication milestones, shipment status, delivery confirmations, and projected availability dates. These procurement events are normalized into time-stamped data objects and programmatically associated with corresponding activities or milestones in the temporal data structure. This association enables the system to computationally propagate supply constraints through dependency relationships, allowing procurement-driven impacts to influence schedule state, risk evaluation, and forecast outputs without manual intervention.

Schedule execution data is further supplied through a schedule data interface 1203 that provides reported progress information, including actual start and finish dates, percent complete values, remaining duration estimates, and updated activity states. These execution signals are mapped to existing temporal elements and used to update state variables within the temporal data structure. The continuous integration of execution data enables reconciliation between planned and observed execution while preserving the integrity of the underlying dependency relationships.

Additional execution evidence is provided by a site monitoring interface 1204 that ingests onsite observations, image and video data, and sensor data reflecting physical project conditions. Image, video and sensor inputs may be processed using computer vision or signal analysis routines to derive structured execution indicators, such as inferred task completion or equipment utilization. These indicators are temporally aligned with schedule activities and incorporated as supplemental state updates, improving the fidelity of progress computation and reducing reliance on subjective reporting.

All heterogeneous inputs are ingested by an integrated project control system 1205 that normalizes and synchronizes the incoming data into a unified temporal data model stored in non-transitory memory. The system constructs and maintains a temporal data structure representing activities or milestones and their temporal dependency relationships, such as a directed dependency graph or equivalent representation. State variables associated with temporal elements are updated dynamically in response to execution, procurement, and monitoring inputs, ensuring that downstream analytics operate on a single authoritative model rather than fragmented data sources.

A project progress analytics module 1206 operates on the unified temporal data model to compute planned, actual, and forecasted progress metrics. Progress values are computed through algorithmic evaluation of activity state transitions, duration consumption ratios, and traversal of dependency relationships. Weighting functions derived from dependency sensitivity or downstream impact are applied so that activities with greater temporal influence contribute proportionally more to aggregated progress metrics. The resulting outputs are stored as time-indexed data structures that capture progress evolution across selectable portions of the schedule, including entire projects, milestone groupings, or user-defined activity sets.

Schedule quality and change analysis routines evaluate the structural integrity of the temporal data structure by applying validation rules and differential comparison algorithms to successive schedule states. These routines identify missing or dangling dependencies, anomalous durations, logic violations, and changes in sequencing or criticality. Quantitative quality indicators are generated and stored as attributes of schedule instances, enabling objective comparison across versions and informing the reliability of predictive outputs.

Predictive risk assessment functionality treats the temporal data structure as a probabilistic network rather than a deterministic plan. Activity-level criticality scores are computed based on dependency position, float sensitivity, milestone proximity, historical slippage patterns, and resource coupling. Aggregation of these scores produces risk density representations that identify regions of concentrated propagation risk. A dynamically updated risk register links computed probability and impact parameters to specific activities or milestones and is recalculated as temporal state variables change.

Completion forecasting functionality executes probabilistic modeling and machine learning inference using models trained on historical project datasets. These models estimate duration uncertainty and delay propagation tendencies based on activity attributes and dependency topology. Simulation routines generate best-case, worst-case, and most-likely completion dates for activities and milestones, as well as completion date distributions for the overall project. Forecast deviations are computationally attributed to specific dependency paths or delay drivers, enabling scenario evaluation prior to execution changes.

An automated reporting engine retrieves analytic outputs from the progress analytics, quality analysis, risk assessment, and forecasting routines and transforms them into structured report data objects according to predefined templates stored in memory. Reports are generated programmatically without manual interpretation and may be produced automatically upon detection of a schedule update or on demand. This automated transformation reduces latency between model updates and system outputs while ensuring consistent algorithmic interpretation of schedule data.

Narrative generation functionality converts quantitative analytic outputs into structured textual descriptions using rule-based logic or trained language models.

The generated narratives reference specific activities, milestones, dependency paths, or forecast deviations represented within the temporal data structure and are embedded directly into report objects, preserving traceability between textual explanations and underlying computations.

The system further produces interactive performance reports 1212 that render progress curves, quality indicators, and forecast distributions through a user interface supporting temporal navigation and drill-down. These interactions modify presentation parameters without altering the underlying temporal data model. At a higher aggregation level, portfolio alerting 1213 functionality evaluates analytic outputs across multiple projects to identify threshold breaches or trend-based risk signals and generates structured alert objects linked to affected schedule elements.

Finally, executive-level insight 1214 outputs synthesize progress, quality, risk, and forecast analytics into high-level indicators representing delivery confidence and execution health. These insights are computationally derived from the authoritative temporal data structure, enabling decision-makers to assess project state without manual synthesis while preserving the ability to trace each indicator back to specific schedule elements, dependencies, and algorithmic evaluations.

In one embodiment, the system includes a project progress analytics module implemented as a computer-executed process that computes, monitors, and displays real-time progress metrics derived from machine-readable schedule data stored in non-transitory memory. When a schedule file or schedule update is ingested, one or more processors parse activity records, temporal attributes, and dependency relationships to generate structured progress data objects representing planned progress, actual progress, and forecasted progress for selectable portions of the schedule. These portions may include an entire project, a work breakdown structure branch, a milestone grouping, or a user-defined activity set. Progress values are computed using algorithmic evaluation of activity state transitions, duration consumption ratios, and traversal of a dependency graph. Weighting functions may be applied based on critical path membership, milestone proximity, or resource intensity, such that activities with greater downstream impact contribute proportionally more to aggregate progress metrics. The system generates time-indexed progress vectors stored as time-series data structures, which are rendered as planned versus actual progress curves and derived performance indices that computationally reveal divergence between expected and observed execution, enabling early machine-detected identification of schedule underperformance and emerging delivery risk.

Automated reporting functionality is provided through a report generation engine 1207 that programmatically transforms schedule analytics into structured reports without manual interpretation. The engine retrieves analytic outputs produced by the progress analytics, schedule quality analysis 1208, risk assessment 1209, and completion forecasting modules 1210, and maps those outputs into report data structures according to predefined or user-configured templates stored in memory. A narrative generation engine 1211 executes natural-language generation routines that transform quantitative analytic outputs into structured textual descriptions using rule-based logic or trained language models. The generated narratives reference specific milestones, activity groupings, detected changes between schedule versions, or forecast deviations, and are embedded directly into report objects alongside machine-generated charts and tables. Report generation may be triggered automatically upon ingestion of a new schedule version or executed on demand, thereby reducing computational latency between schedule modification and executive-level visibility while ensuring consistent algorithmic interpretation of complex schedule data.

Schedule quality and change analysis is performed using computer-executed validation and comparison routines operating on successive schedule versions. A schedule quality score is computed by evaluating multiple structural integrity metrics, including completeness of dependency relationships, detection of missing or dangling links within a dependency graph, identification of statistically anomalous activity durations, and compliance with predefined schedule logic constraints stored as validation rules. The quality score is stored as a quantitative reliability indicator associated with a schedule version and enables objective comparison across versions or across projects.

Version-to-version change analysis is executed using differential comparison algorithms that identify and classify changes in scope, timing, and logic, including activity additions or deletions, duration modifications, dependency rewiring, and shifts in critical path membership. These changes are aggregated into structured change datasets that distinguish execution-driven variance from variance introduced by schedule restructuring, while trend analysis routines operate across multiple versions to detect recurring degradation or improvement patterns that are not observable from individual schedule snapshots.

Predictive risk assessment functionality treats the schedule as a probabilistic temporal network rather than a deterministic plan. A criticality modeling engine computes a quantitative criticality score for each activity by evaluating its position within the dependency graph, proximity to one or more milestones, float sensitivity, historical slippage patterns derived from prior schedules, and resource dependency relationships. Unlike binary critical path classification, the criticality score expresses the computed sensitivity of downstream milestone outcomes to perturbations in an activity's duration or execution state. Risk density representations are generated by aggregating criticality scores across the network to identify regions with concentrated propagation risk. A dynamically updated risk register is maintained in non-transitory memory, with each risk entry programmatically linked to one or more activities or milestones and including probability and impact parameters that are recomputed as schedule state variables change. Quantitative schedule risk analysis simulations may be executed using stochastic modeling techniques, including Monte Carlo simulation, to generate probability distributions for milestone and project completion dates and to compute confidence levels and schedule contingency values.

Completion forecasting and scenario simulation functionality is implemented using machine learning models trained on historical project datasets stored in a training corpus. The models learn statistical relationships between activity attributes, dependency topology, and observed execution outcomes in order to estimate duration uncertainty and delay propagation tendencies. For a given schedule state, inference routines compute best-case, worst-case, and most-likely completion dates for activities and milestones, and aggregate these values to generate completion date distributions for the overall project. Milestones whose predicted completion dates deviate beyond predefined thresholds relative to baseline or contractual targets are identified, and such deviations are attributed to specific delay drivers within the dependency graph. Scenario simulation is supported by enabling modification of schedule parameters such as sequencing, scope inclusion, or resource allocation, followed by automated re-execution of forecasting and risk models to computationally evaluate the impact of proposed changes prior to implementation.

Portfolio assurance functionality aggregates project-level analytics across multiple projects into a unified portfolio-level computational model. Progress, risk, quality, and forecast metrics generated at the project level are normalized using standardized metric definitions and stored as portfolio data objects. These objects are presented as standardized scorecards that enable algorithmic comparison across projects, geographic regions, contractors, or asset classes. Hierarchical drill-down operations allow traversal from portfolio-level indicators to individual projects, milestones, and underlying activities, enabling users to identify the specific schedule elements responsible for portfolio-wide risk signals without executing separate reporting workflows.

The analytics and forecasting functionality is integrated with a collaborative workflow and execution coordination layer implemented as a task orchestration subsystem. When an analytic output satisfies predefined actionability criteria, the system automatically generates workflow artifacts encoded as task objects that encapsulate the detected issue, supporting analytic data, and one or more recommended actions. These task objects are assigned to responsible users using role-based access controls and tracked through state transitions stored in memory. An execution coordination subsystem aligns contractor-provided execution inputs with an owner-controlled milestone framework by restricting write access to authoritative temporal data structures while allowing controlled submission and evaluation of proposed sequencing or dependency changes. Proposed changes are evaluated using validation rules and predictive impact analysis prior to incorporation, preserving centralized schedule governance while enabling structured, computer-mediated collaboration around execution recovery strategies.

The system further includes a project collaboration subsystem implemented as a computer-executed coordination layer that operates directly on structured schedule data rather than on unstructured communications. The collaboration subsystem is coupled to schedule analysis, forecasting, and workflow orchestration processes and is configured to generate, store, route, and track collaboration artifacts as machine-interpretable objects maintained in non-transitory memory. Each collaboration artifact is programmatically linked to one or more activities, milestones, dependency paths, or risk indicators represented in an authoritative temporal data structure, such that collaborative interactions are computationally bound to schedule state.

Upon detection by a processor of a schedule condition satisfying one or more predefined criteria, including threshold deviations, risk propagation scores, or forecast confidence degradation, the system automatically generates a collaboration object associated with the affected schedule elements. The collaboration object encapsulates structured data identifying the triggering condition, associated activity identifiers, dependency relationships, analytic metrics, and system-generated recommendations. The object is assigned to one or more users based on role-based responsibility mappings and access controls stored in memory, and is tracked through a defined set of state transitions corresponding to acknowledgement, analysis, resolution, or escalation. By representing collaboration as structured, stateful objects rather than free-form messages, the system improves the operation of collaborative project computing systems by ensuring consistency, traceability, and computational relevance of user interactions.

User interactions with collaboration objects are captured as discrete, time-stamped events that modify object state without directly altering the underlying schedule graph. Concurrency controls and version management routines ensure that collaborative input does not overwrite or fragment the authoritative temporal model. Proposed schedule changes submitted through the collaboration subsystem are stored as candidate modifications and evaluated by the processor using validation rules and predictive impact analysis prior to incorporation. This architecture enables coordinated multi-user interaction while preserving integrity of the schedule computation layer.

The system further includes schedule build and optimization functionality implemented as a set of processor-executed algorithms that construct and refine schedules using physical scope representations and computational constraint modeling. Input data may include design models, scope definitions, quantity data, and historical productivity records, which are transformed into machine-readable scope objects and work packages. These scope objects are mapped to executable activities using rule-based sequencing logic and learned productivity models stored in memory.

An initial schedule is constructed as a directed dependency graph in which nodes correspond to activities and edges represent temporal, logical, or resource-based constraints. Constraint solvers and optimization routines are applied to the dependency graph to generate one or more feasible schedule configurations that satisfy defined objectives, including milestone targets, labor and equipment availability, shift patterns, and supply constraints. Each configuration is stored as a distinct graph instance and evaluated using objective functions that quantify schedule risk, resource contention, and dependency sensitivity.

Schedule optimization is performed iteratively by executing simulation and evaluation routines that assess candidate schedules under modeled uncertainty.

Stochastic simulation techniques are applied to estimate completion probability distributions for milestones and to compute comparative fitness metrics for each candidate configuration. The processor ranks schedule configurations based on these metrics and identifies optimized schedules that improve forecast confidence or reduce risk concentration relative to baseline configurations. This computational approach enables systematic evaluation of scheduling alternatives that cannot be practically assessed through manual planning.

During execution, the system continuously updates the dependency graph using progress data, procurement status changes, and validated collaboration inputs.

Updates to node state or edge constraints trigger recalculation of dependency paths and re-execution of optimization routines. When updated conditions materially affect forecast outcomes, the system generates revised schedule configurations and presents them as structured proposals through the collaboration subsystem, each accompanied by computed impact metrics. Adoption of a revised configuration occurs only after validation checks are satisfied, thereby preventing degradation of schedule integrity.

By implementing collaboration as a structured, computer-mediated process tied directly to schedule computation, and by automating schedule construction and optimization using graph-based representations, constraint solvers, and predictive simulation, the disclosed system provides a specific improvement to project scheduling and collaboration computing systems. The system reduces reliance on manual schedule authoring, prevents fragmentation of schedule state during collaboration, and enables algorithmic generation and refinement of schedules based on physical scope and execution constraints rather than retrospective reporting.

These features collectively improve the functioning of project delivery computing systems by enabling consistent, low-latency coordination driven by real-time schedule analytics and by executing automated schedule build and optimization processes that transform heterogeneous input data into executable temporal models.

In one embodiment, the disclosed system implements a computer-executed project intelligence platform configured to process heterogeneous project data using artificial intelligence and algorithmic analytics operating on an authoritative temporal data model stored in non-transitory memory. The system is architected to support multiple classes of project stakeholders through differentiated computational outputs derived from a common underlying schedule graph, rather than through role-specific data silos or manually curated reports.

The system ingests machine-readable schedule files, procurement records, site monitoring data, execution updates, and historical project datasets. One or more processors normalize the ingested data into structured data objects representing activities, dependencies, milestones, resources, procurement events, and execution states. These objects are stored within a unified temporal data model implemented as a directed dependency graph, enabling algorithmic traversal, modification, and analysis of project time behavior.

Artificial intelligence components are applied at multiple stages of system operation. In particular, machine learning models trained on historical project datasets are used to estimate activity duration uncertainty, delay propagation tendencies, and resource-driven variance. These models are invoked during progress computation, risk assessment, and completion forecasting to generate probabilistic outputs that cannot be produced through deterministic scheduling logic alone.

Progress analytics functionality is implemented as a processor-executed module that computes planned, actual, and forecasted progress states by evaluating activity state transitions, duration consumption ratios, and dependency graph traversal.

Weighting functions derived from learned criticality measures, milestone proximity, and resource coupling are applied such that activities with higher downstream sensitivity contribute proportionally more to aggregate progress metrics. The resulting progress vectors are stored as time-indexed data structures and continuously updated as new execution evidence is ingested.

Schedule quality and change analysis is performed using validation algorithms that operate on successive schedule graph instances. The system computes quantitative quality scores based on dependency completeness, constraint compliance, anomaly detection, and logic stability. Change detection routines execute differential graph comparisons to identify scope modifications, dependency rewiring, and critical path migration. Artificial intelligence models are further applied to identify non-obvious degradation patterns across schedule versions that are not detectable through single-snapshot analysis.

Predictive risk assessment functionality treats the schedule graph as a probabilistic temporal network. A criticality modeling engine computes continuous criticality scores for activities using graph topology, float sensitivity, historical slippage data, and learned propagation behavior. Risk density maps are generated by aggregating criticality values across dependency regions. Stochastic simulation techniques, including Monte Carlo simulation augmented by learned uncertainty distributions, are executed to generate completion probability distributions and schedule contingency values.

Completion forecasting and scenario simulation are further enhanced through machine learning inference. Trained models estimate best-case, most-likely, and worst-case completion outcomes for activities and milestones based on current schedule state and historical analogs. The system supports automated scenario evaluation by modifying sequencing, scope inclusion, resource allocation, or procurement timing and re-executing forecasting and risk models to quantify downstream effects prior to implementation.

Automated reporting functionality is implemented as a report generation engine that programmatically transforms analytic outputs into structured report objects. A narrative generation subsystem executes natural-language generation routines, including rule-based logic and trained language models, to convert quantitative analytic results into structured textual explanations. These narratives are computationally linked to underlying data objects, milestones, and analytic states, ensuring traceability and consistency.

The system further includes an execution coordination and collaboration layer implemented as a computer-executed workflow subsystem. When analytic outputs satisfy predefined actionability criteria, processors automatically generate collaboration objects encoded as stateful task records that include triggering conditions, linked schedule elements, analytic metrics, and AI-generated recommendations. These objects are routed and tracked using role-based access controls and state transition logic, while concurrency management routines prevent unauthorized modification of authoritative temporal data.

For large-scale infrastructure projects, including data centers and public-sector developments, the system explicitly models procurement-driven dependencies and long-lead equipment constraints within the dependency graph. Artificial intelligence is applied to predict cascading delay risk arising from supply-chain perturbations and to recommend mitigation strategies based on learned recovery patterns from historical projects.

By integrating artificial intelligence, graph-based schedule representations, probabilistic simulation, and automated collaboration into a single processor-executed platform, the disclosed invention provides a specific technological improvement to project delivery computing systems. The system replaces manual schedule interpretation, fragmented toolchains, and retrospective reporting with continuous, AI-assisted computation of progress, risk, and forecast states, thereby improving the accuracy, responsiveness, and reliability of computer-implemented project control operations

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of configurations. In addition, any disclosure of components contained within other components should be considered as examples because many other architecture may be implemented to achieve the same functionality.

Although the subject matter has been described in language specific to structural features and/or methodological acts, it is to be understood that the subject matter defined in this disclosure is not necessarily limited to the specific features or acts described above. Rather, the specific features and acts described above are disclosed as example forms of implementing this disclosure.

Embodiments according to the invention are thus described. While the present invention has been described in particular embodiments, the invention should not be construed as limited by such embodiments, but rather construed according to the following claims.

What is claimed is:

1. An integrated project control computing system, comprising:
one or more processors; and
non-transitory memory storing computer-executable instructions that, when executed by the one or more processors, cause the one or more processors to:
read heterogeneous project data comprising machine-readable schedule data, procurement data, and execution progress data;
normalize the heterogeneous project data into structured data objects stored in the non-transitory memory;
construct and maintain a temporal data structure that represents activities or milestones and temporal dependency relationships among the activities or milestones;
update state variables of the temporal data structure based on execution progress data;
compute planned, actual, and forecasted progress metrics by evaluation of activity state transitions, duration consumption values, and the temporal data structure;
apply weighting functions derived from dependency sensitivity or downstream impact as determined from the temporal data structure to the computed progress metrics;
execute schedule quality analysis and change detection by performing validation and differential comparison operations on successive instances of the temporal data structure;
perform predictive risk assessment and completion forecasting by executing probabilistic modeling and machine learning inference on the temporal data structure using models trained on historical project datasets; and
generate machine-derived output data comprising progress indicators, risk metrics, and forecasted completion states that are recomputed in response to changes in the temporal data structure.

2. The system of claim 1, wherein the heterogeneous project data further comprises site monitoring data including onsite observations, image data, or sensor data, and wherein the one or more processors associate the site monitoring data with corresponding nodes of the directed dependency graph.

3. The system of claim 1, wherein the directed dependency graph encodes at least one of logical dependencies, temporal constraints, or resource-based constraints between activities.

4. The system of claim 1, wherein the schedule quality analysis computes a quantitative schedule quality score based on dependency completeness, constraint compliance, and detection of anomalous activity durations.

5. The system of claim 1, wherein the predictive risk assessment treats the directed dependency graph as a probabilistic temporal network and computes continuous criticality scores for activities.

6. The system of claim 9, wherein the continuous criticality scores are computed based on graph topology, float sensitivity, historical slippage patterns, and resource dependency relationships.

7. The system of claim 1, wherein the probabilistic modeling comprises executing stochastic simulation to generate probability distributions for milestone or project completion dates.

8. The system of claim 1, wherein the machine learning inference estimates best-case, most-likely, and worst-case completion outcomes for activities or milestones.

9. The system of claim 1, further comprising an automated reporting engine configured to generate structured report objects from the machine-derived output data.

10. The system of claim 13, further comprising a narrative generation subsystem configured to generate textual explanations corresponding to the machine-derived output data using rule-based logic or trained language models.

11. The system of claim 11, wherein the collaboration and execution coordination subsystem enforces concurrency controls that prevent unauthorized modification of the authoritative temporal data structure.

12. The system of claim 1, further comprising a schedule build and optimization module configured to generate executable schedules from physical scope representations using rule-based sequencing logic.

13. The system of claim 1, wherein procurement data is represented as time-based dependency constraints within the directed dependency graph such that changes in procurement status propagate to downstream activities.

14. The system of claim 1, further comprising portfolio assurance logic configured to aggregate progress indicators, risk metrics, and forecasted completion states across a plurality of projects into normalized portfolio-level data objects.

15. The system of claim 1, wherein the machine-derived output data is recomputed automatically in response to ingestion of updated schedule data, procurement data, or execution progress data 16. A computer-implemented method for integrated project control, comprising:
receiving, by one or more processors, heterogeneous project data comprising machine-readable schedule data, procurement data, and execution progress data;
normalizing, by the one or more processors, the heterogeneous project data into structured data objects stored in non-transitory memory;
constructing and maintaining, by the one or more processors, a temporal data structure representing activities or milestones and temporal dependency relationships therebetween;
updating, by the one or more processors, state variables of the temporal data structure based on the execution progress data;
computing, by the one or more processors, planned, actual, and forecasted progress metrics by executing algorithmic evaluation of activity state transitions, duration consumption values, and traversal of the temporal data structure;
applying, by the one or more processors, weighting functions to the progress metrics, the weighting functions being derived from dependency sensitivity or downstream impact determined from the temporal data structure;
performing, by the one or more processors, schedule quality analysis and change detection by executing validation and differential comparison operations on successive instances of the temporal data structure;
performing, by the one or more processors, predictive risk assessment and completion forecasting by executing probabilistic modeling and machine learning inference on the temporal data structure using models trained on historical project datasets; and
generating output data comprising progress indicators, risk metrics, and forecasted completion states by recomputing analytic results in response to changes in the temporal data structure.

17. The method of claim 16, wherein constructing the temporal data structure comprises generating a directed dependency graph in which nodes correspond to activities or milestones and edges correspond to temporal, logical, or resource-based dependencies.

18. The method of claim 16, wherein updating the state variables comprises modifying start states, completion states, remaining duration values, or constraint satisfaction indicators associated with activities represented in the temporal data structure.

19. The method of claim 16, wherein performing the completion forecasting comprises executing stochastic simulation routines to generate probability distributions for milestone or project completion dates.

20. The method of claim 16, wherein performing the completion forecasting further comprises computing best-case, worst-case, and most-likely completion dates for activities or milestones by applying trained duration uncertainty models.

21. The method of claim 16, further comprising ingesting procurement data representing long-lead material or equipment events and associating the procurement data with corresponding activities or milestones in the temporal data structure.

22. The method of claim 16, further comprising propagating procurement-driven temporal constraints through the temporal data structure to modify forecasted completion states.

23. The method of claim 16, further comprising generating structured report data objects by programmatically mapping the progress indicators, risk metrics, and forecasted completion states into predefined report templates stored in memory.

24. The method of claim 16, further comprising generating narrative text by executing natural-language generation routines that transform quantitative analytic outputs into structured textual descriptions linked to activities, milestones, or dependency paths represented in the temporal data structure.

25. An integrated project control computing apparatus, comprising:
one or more processors;
non-transitory memory storing computer-executable instructions;
a data input component configured to receive heterogeneous project data comprising schedule-related data identifying activities or milestones and associated timing information, execution-related data indicating progress or completion state of the activities or milestones, and supply-related data indicating availability or delivery timing of materials, equipment, or services;
a data normalization component configured to convert the heterogeneous project data into structured data objects stored in the non-transitory memory;
a temporal modeling component configured to maintain a temporal representation comprising a plurality of activities or milestones, and machine-interpretable temporal relationships defining ordering or dependency between the activities or milestones;
an update component configured to modify the temporal representation in response to changes in at least one of the execution-related data or the supply-related data;
a computation component configured to compute project progress information, risk information, or forecast information by executing processor-based evaluation of the temporal representation; and
an output generation component configured to generate output data representing a computed execution state of the project, wherein the output data changes automatically when the temporal representation is modified.

26. The apparatus of claim 25, wherein the temporal modeling component maintains the temporal relationships as a dependency-based structure used during computation of the project progress information, risk information, or forecast information.

27. The apparatus of claim 25, wherein the computation component computes the risk information or forecast information by executing probabilistic modeling or machine learning inference using one or more trained models stored in the non-transitory memory.

28. The apparatus of claim 25, wherein the output generation component is configured to automatically recompute the output data upon detection of changes in execution progress data, supply-related data, or the temporal relationships.
